(19) United States
(12) Patent Application Publication
(10) Pub. No.: US 2025/0181099 A1
(43) Pub. Date: Jun. 5, 2025

(54) CHIP WITH A CURRENT-MIRROR-LIKE VOLTAGE SOURCE

(71) Applicant: MEDIATEK INC., Hsinchu City (TW)

(72) Inventor: Jing-Hao HUANG, Hsinchu City (TW)

(21) Appl. No.: 18/944,660

(22) Filed: Nov. 12, 2024

Related U.S. Application Data
(60) Provisional application No. 63/604,253, filed on Nov. 30, 2023.

(51) Int. Cl. G05F 3/26

(52) U.S. Cl. CPC G05F 3/262

(57) ABSTRACT

A chip with a current-mirror-like voltage source is shown. The current-mirror-like voltage source has a first n-channel Metal-Oxide-Semiconductor Field-Effect Transistor (NMOS), a second NMOS, and an operational amplifier. The first and second NMOSs have drains coupled to a first voltage source Vdd1. The operational amplifier has an output terminal coupled to the gates of the first NMOS and the second NMOS, a negative input terminal coupled to the source of the first NMOS to form a negative feedback loop, and a positive input terminal coupled to the source of the second NMOS to form a positive feedback loop. The operational amplifier is powered by a second voltage source that is greater than the first voltage source, to operate the first and second NMOSs in their saturation region, and thereby the current-mirror-like voltage source outputs a load current mirrored from a first current.

### CROSS REFERENCE TO RELATED APPLICATIONS

This application claims the benefit of U.S. Provisional Application No. 63/604,253, filed Nov. 30, 2023, the entirety of which is incorporated by reference herein.

### BACKGROUND OF THE INVENTION

### Field of the Invention

The present invention relates to power design on a chip.

### Description of the Related Art

FIG. 1 depicts a conventional power design on a chip. As illustrated, a low-dropout regulator (LDO) 102 and a current mirror 104 are provided to power the load RL. The LDO 102 uses an n-channel Metal-Oxide-Semiconductor Field-Effect Transistor (NMOS) Mn as a power MOS to improve the power supply rejection ratio (PSRR). The regulated voltage (e.g., 0.85V) generated by the LDO 102 powers the current mirror 104 to generate a load current IL to drive the load RL. The current mirror 104 uses a p-channel Metal-Oxide-Semiconductor Field-Effect Transistor (PMOS) Mp to provide the load current IL to the load RL. The cascaded NMOS Mn and PMOS Mp need to share limited headroom (e.g., 1V-0.6V). The PMOS Mp may introduce a power supply jitter (PSJ) from the 1V voltage source to the load RL, which may be 3%˜5% UI (abbreviated from Unit Interval (UI) in general high-speed SerDes application) in general.

### BRIEF SUMMARY OF THE INVENTION

The present invention introduces a novel power design on a chip, which includes a voltage source structure that operates as a current source in an improved power supply rejection ratio (PSRR). Such a voltage source structure is named a current-mirror-like voltage source.

In an exemplary embodiment, a chip with the current-mirror-like voltage source is shown. The current-mirror-like voltage source has a first n-channel Metal-Oxide-Semiconductor Field-Effect Transistor (NMOS), a second NMOS, and an operational amplifier. The first NMOS and the second NMOS have drains coupled to a first voltage source. The operational amplifier, having an output terminal coupled to the gates of the first NMOS and the second NMOS has a negative input terminal coupled to a source of the first NMOS to form a negative feedback loop, and a positive input terminal coupled to a source of the second NMOS to form a positive feedback loop. The operational amplifier is powered by a second voltage source that is greater than the first voltage source, to operate the first NMOS and the second NMOS in their saturation region, and thereby the current-mirror-like voltage source outputs a load current mirrored from a first current.

In an exemplary embodiment, the chip further has a low-resistive load. The low-resistive load is driven by the load current, and has a resistance that is lower than a threshold, which guarantees that the current-mirror-like voltage source is operating in its stable region.

In an exemplary embodiment, the chip further has a charge pump and a low-pass filter. The charge pump pumps the first voltage source to the second voltage source. The low-pass filter is coupled at an output terminal of the charge pump, to filter the second voltage source and to couple the filtered second voltage source to the operational amplifier. In this manner, the power supply jitter (PSJ) introduced to the load is considerably suppressed.

In an exemplary embodiment, the drains of the first and second NMOSs are directly coupled to the first voltage source without passing through any transistors.

In an exemplary embodiment, the source of the second NMOS is directly coupled to a low-resistive load without passing through any transistors.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 depicts a conventional power design on a chip;

FIG. 2 illustrates a power design in accordance with an exemplary embodiment of the disclosure;

FIG. 3 illustrates the DC analysis of the circuit of FIG. 2;

FIG. 4 illustrates a power design in accordance with another exemplary embodiment of the disclosure; and

FIG. 5 illustrates the DC analysis of the circuit of FIG. 4.

### DETAILED DESCRIPTION OF THE INVENTION

The following description enumerates various embodiments of the disclosure, but is not intended to be limited thereto. The actual scope of the disclosure should be defined according to the claims. The various blocks may be implemented by special circuits. The circuit components may be directly connected to each other without additional components as the circuit illustrated in the figures. Or, there may be some additional components coupled between the illustrated circuit components.

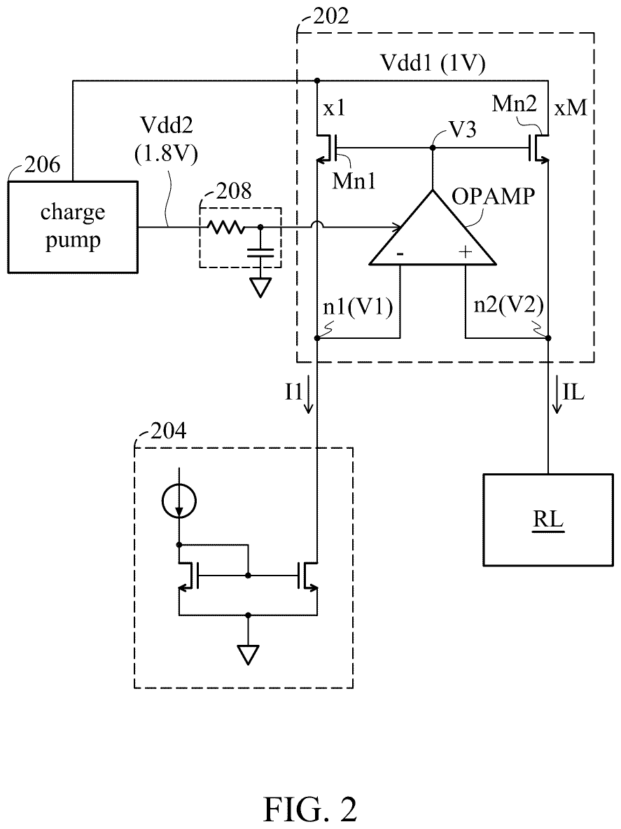

FIG. 2 illustrates a power design in accordance with an exemplary embodiment of the disclosure. The load RL is driven by a stable load current IL provided by a current-mirror-like voltage source 202 introduced in the disclosure.

The current-mirror-like voltage source 202 includes a first n-channel Metal-Oxide-Semiconductor Field-Effect Transistor (NMOS) Mn1, a second NMOS Mn2, and an operational amplifier OPAMP. The drains of the first and second NMOSs Mn1 and Mn2 both are coupled to a first voltage source Vdd1 (e.g., 1V). The gates of the first NMOS Mn1 and second NMOS Mn2 both are controlled by the operational amplifier OPAMP. The positive input terminal of the operational amplifier OPAMP is coupled to a source of the second NMOS Mn2 to form a positive feedback loop. The negative input terminal of the operational amplifier OPAMP is coupled to a source of the first NMOS Mn1 to form a negative feedback loop. Especially, the operational amplifier OPAMP is powered by a second voltage source Vdd2 (e.g., 1.8V) that is greater than the first voltage source Vdd1 (e.g., 1V). Thus, the operational amplifier OPAMP owns the capability to turn on the first and second NMOSs Mn1 and Mn2 to work the positive feedback loop and the negative feedback loop. Based on the concept of a negative impedance converter, an NMOS source follower controlled by an operational amplifier OPAMP form the current-mirror-like voltage source 202.

In the disclosure, the operational amplifier OPAMP powered by the second voltage source Vdd2 (greater than the first voltage source Vdd1) operate the first NMOS Mn1 and the second NMOS Mn2 in their saturation region, and thereby the current-mirror-like voltage source 202 outputs the load current IL mirrored from a first current I1.

Specifically, the load RL driven by the load current IL is a low-resistive load that has a resistance that is under a threshold, guaranteeing that the current-mirror-like voltage source 202 is operating in its stable region. The low-resistive load (RL) may be a ring oscillator, or any current-driven device.

In the example presented in FIG. 2, the second NMOS Mn2 is M times larger than the first NMOS Mn1 in size. A first connection node n1 between the source of the first NMOS Mn1 and the negative input terminal of the operational amplifier OPAMP is coupled to a current mirror 204 that determines the first current I1. A second connection node between the source of the second NMOS Mn2 and the positive input terminal of the operational amplifier OPAMP is coupled to the load RL to provide the load current IL (MxI1, mirrored from the first current I1) to drive the load RL.

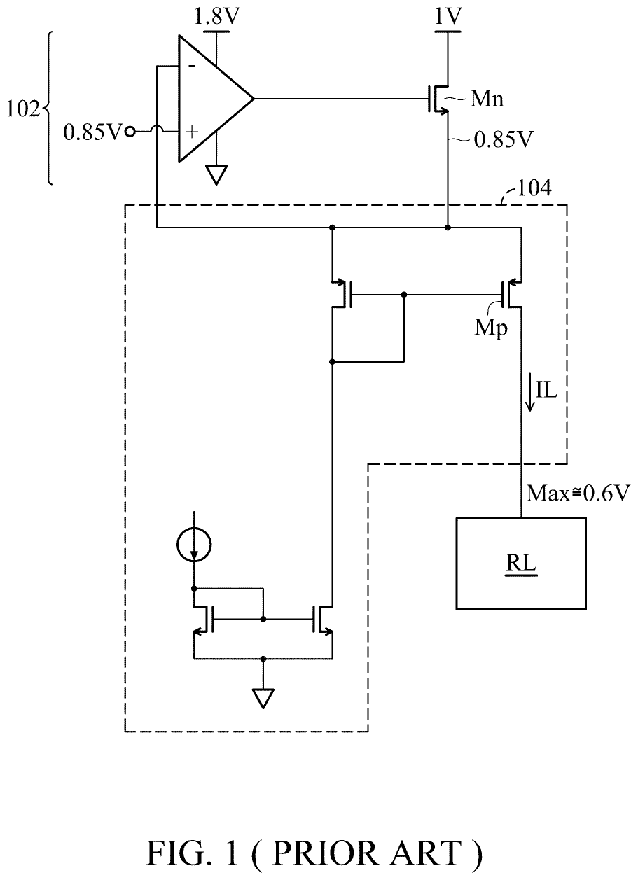

In FIG. 2, the drains of the first and second NMOSs Mn1 and Mn2 are directly coupled to the first voltage source Vdd1 without passing through any transistors, and the source of the second NMOS Mn2 is directly coupled to the load RL without passing through any transistors. Different from the NMOS Mn of the LDO 102 and the PMOS pair of the current mirror 104 which are cascaded as shown in FIG. 1 to share the limited headroom, the voltage headroom for operating the NMOS pair (Mn1 and Mn2) of the proposed current-mirror-like voltage source 202 is much wider.

FIG. 2 further shows a charge pump 206 and a low-pass filter 208. The charge pump 206 pumps the first voltage source Vdd1 (1V) to the second voltage source Vdd2 (1.8V). The second voltage source Vdd2 (1.8V) is filtered by the low-pass filter 208 before being coupled to the operational amplifier OPAMP. Because the operational amplifier OPAMP is a power-saving design, the size of the low-pass filter 208 can be small. The clean second voltage source Vdd2 (1.8V) improves the PSRR. Rather than being affected by the noisy 1V source as shown in FIG. 1, the operations of the load RL in FIG. 2 is more dependent on the clean 1.8V voltage source as shown, and the PSJ may suppressed to just 1% or smaller.

In another exemplary embodiment, both the first voltage source Vdd1 (1V) and the second voltage source Vdd2 (1.8V) are external voltage sources. The charge pump 206 and the low-pass filter 208 are not required.

In another exemplary embodiment, the bias voltage V3 is generated by directly pumping the first voltage source technique is applied to generate V3 based on voltage with only Vdd1. The charge pump 206 and the low-pass filter 208 are not required in such a design. Or, the charge pump 206 and the low-pass filter 208 may be merged in such a pumping technique.

The conditions to be met for the operations of the current-mirror-like voltage source 202 are discussed in the following paragraphs. First, the first NMOS Mn1 and the second NMOS Mn2 need to be operated in their saturation region. Furthermore, the current-mirror-like voltage source 202 need to operate in its stable region.

To guarantee the saturation status of the first NMOS Mn1 and the second NMOS Mn2, the bias voltage V3 generated by the operational amplifier OPAMP needs to be greater than (V1+Vth1), and also greater than (V2+Vth2). V1 is the first voltage at the source of the first NMOS Mn1. V2 is the second voltage at the source of the second NMOS Mn2. The threshold voltage of the first NMOS Mn1 is Vth1, and the threshold voltage of the second NMOS Mn2 is Vth2. In more details, V3 is smaller than Vdd1 plus Vth1, and is also smaller than Vdd1 plus Vth2 where Vdd1 is the first voltage source.

As for the stability issue, the negative feedback loop needs to be stronger than the positive feedback loop. The resistance viewed from the source of the first NMOS Mn1 into the current mirror 204 is a first resistance R1 (=V1/I1). The threshold to define a low-resistive load for implementing the load RL may depend on a first resistance R1 (=V1/I1) as well as a size ratio M of the second NMOS Mn2 to the first NMOS Mn1. For example, the threshold may be R1/M. A low-resistive load has a resistance that is lower than R1/M is suitable for use with the current-mirror-like voltage source 202.

In another exemplary embodiment, the size (xM) of the second NMOS Mn2 depends on the ratio R1/RL. For example, when R1/RL is 40, M should be smaller than 40 (e.g., M=32), and thereby the negative feedback loop is stronger than the positive feedback loop, and the current-mirror-like voltage source 202 operates stably.

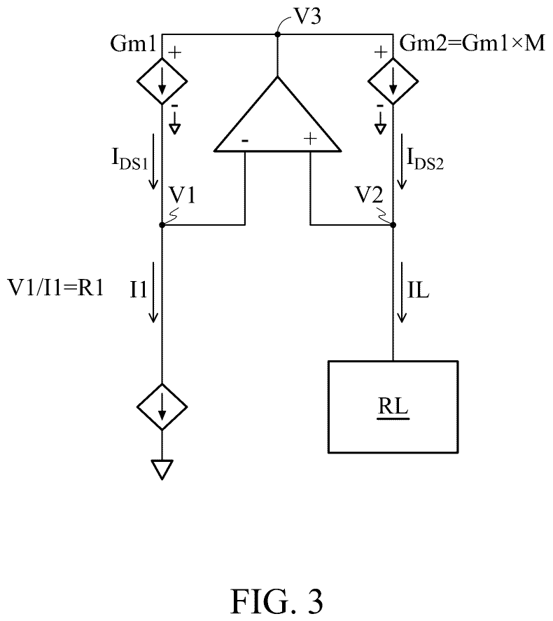

FIG. 3 illustrates the DC analysis of the circuit of FIG. 2, wherein the first NMOS Mn1 is represented by its transconductance Gm1, and the second NMOS Mn2 is represented by its transconductance Gm2 (=M×Gm1). In such a structure, V1=V2, and I_{DS2}=M×I_{DS1} (=M×I1). The operation of the circuit can be derived by the following mathematical derivation:

$$\begin{matrix}∵ RL = \frac{V 2}{IL} = \frac{V 1}{{I}_{D S 2}} = \frac{V 1}{I 1 \times M} = \frac{R 1}{M} \\ ∴ IL = \frac{V 2}{R L} = \frac{V 1}{R L} = \frac{I 1 \times R 1}{R 1 / M} = M \times I 1 ; IL ∝ I 1\end{matrix}$$

A current like behavior is shown.

As for the stability analysis, the stable of the dual loop structure is achieved by having a negative feedback gain greater than a positive feedback gain, so that:

$$\begin{matrix}Gm 1 \times R 1 > Gm 2 \times RL \\ ⇒ {I}_{D S 1} \times R1 > {I}_{D S 2} \times R L \\ ⇒ {I}_{D S 1} \times R1 > {I}_{D S 1} \times M \times R L \\ ⇒ R 1 > M \times RL\end{matrix}$$

The low-resistive load RL using the current-mirror-like voltage source 202 satisfies the following relation: R1>M×RL.

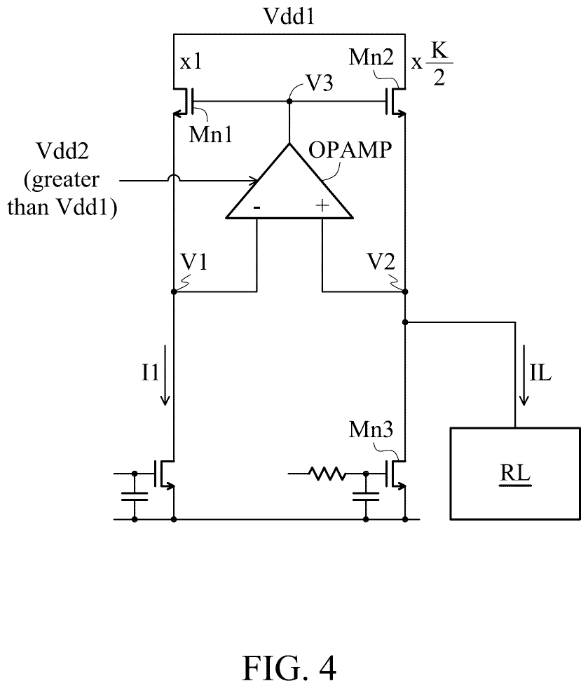

FIG. 4 illustrates a power design in accordance with another exemplary embodiment of the disclosure. Compared to FIG. 2, the power design of FIG. 4 further uses a third NMOS Mn3 to establish an additional current path to adjust the load current IL driving the load RL.

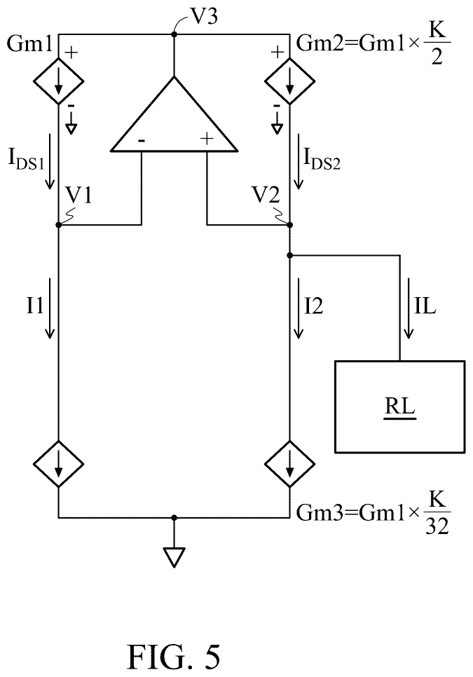

FIG. 5 illustrates the DC analysis of the circuit of FIG. 4, wherein the first NMOS Mn1 is represented by its transconductance Gm1, and the second NMOS Mn2 is represented by its transconductance Gm2 (=Gm1×K/2), and the third NMOS Mn3 is represented by its transconductance Gm3 (=Gm×K/32). In such a structure,

$$V 1 = V 2 , {I}_{D S 2} = \frac{K}{2} \times {I}_{D S 1} ( = \frac{K}{2} \times I 1 ) , and {I}_{2} = \frac{K}{32} \times {I}_{D S 1} ( = \frac{K}{32} \times I 1 ) .$$

The operation of this power design can be derived by the following mathematical derivation:

$$\begin{matrix}∵ RL = \frac{V 2}{IL} = \frac{V 1}{{I}_{D S 2} - I 2} = \frac{V 1}{I 1 \cdot \frac{K}{2} - I 1 \cdot \frac{K}{2}} = \frac{32}{15} \times \frac{V 1}{K \cdot I 1} = \frac{32}{15} \times \frac{R 1}{K} \\ ∴ IL = \frac{V 2}{R L} = \frac{V 1}{R L} = \frac{I 1 \times R 1}{\frac{32}{15} \times \frac{R 1}{K}} = \frac{15}{32} \times K \times I 1 ; IL ∝ I 1\end{matrix}$$

The structure shown in FIG. 4 also owns the current like behavior. The first and second NMOSs Mn1 and Mn2 both operate in their saturation region, wherein:

$$\begin{matrix}V 1 + V th 1 < V 3 < V dd 1 + V th 1 \\ V 2 + V th 2 < V 3 < V dd 1 + V th 2\end{matrix}$$

Furthermore, for the stable behavior of the power design, the resistance of the load RL should be low enough (defined according to the resistance obtained from V1/I1, and the size ratio (K/2) of the first NMOS Mn1 to the second NMOS Mn2) to satisfy the relation that the negative feedback loop be stronger than the positive feedback loop.

In conclusion, any power design using a pair of NMOSs (Mn1 and Mn2) and an operational amplifier (OPAMP) to form a dual-loop source follower as the current-mirror-like voltage source 202 should be considered within the scope of the disclosure.

While the invention has been described by way of example and in terms of the preferred embodiments, it should be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A chip with a current-mirror-like voltage source, wherein the current-mirror-like voltage source comprises:
a first n-channel Metal-Oxide-Semiconductor Field-Effect Transistor (NMOS) and a second NMOS, having drains coupled to a first voltage source; and
an operational amplifier, having an output terminal coupled to gates of the first NMOS and the second NMOS, a negative input terminal coupled to a source of the first NMOS to form a negative feedback loop, and a positive input terminal coupled to a source of the second NMOS to form a positive feedback loop;
wherein the operational amplifier is powered by a second voltage source that is greater than the first voltage source, to operate the first NMOS and the second NMOS in their saturation region, and thereby the current-mirror-like voltage source outputs a load current mirrored from a first current.

2. The chip as claimed in claim 1, further comprising:
a low-resistive load, driven by the load current, and having a resistance that is lower than a threshold that guarantees the current-mirror-like voltage source is operating in its stable region.

3. The chip as claimed in claim 2, wherein:
the threshold depends on a first resistance as well as a size ratio of the second NMOS to the first NMOS;
the first resistance is determined by V1/I1, wherein I1 is the first current, and V1 is a voltage level at a first connection node between the negative input terminal of the operational amplifier and the source of the first NMOS; and
the low-resistive load is coupled to a second connection node between the positive input terminal of the operational amplifier and the source of the second NMOS.

4. The chip as claimed in claim 3, wherein:
the threshold is R1/M,
where R1 is the first resistance, and M is the size ratio.

5. The chip as claimed in claim 1, further comprising:
a ring oscillator, driven by the load current.

6. The chip as claimed in claim 1, further comprising:
a charge pump, pumping the first voltage source to the second voltage source; and
a low-pass filter at an output terminal of the charge pump, to filter the second voltage source and to couple the filtered second voltage source to the operational amplifier.

7. The chip as claimed in claim 1, wherein:
the first voltage source and the second voltage source are external voltage sources coupled to the chip.

8. The chip as claimed in claim 1, wherein:
a first connection node between the negative input terminal of the operational amplifier and the source of the first NMOS is at a first voltage that is represented by V1;
a second connection node between the positive input terminal of the operational amplifier and the source of the second NMOS at a second voltage that is represented by V2;
the operational amplifier outputs a third voltage that is represented by V3;
V3 is greater than V1 plus Vth1, where Vth1 is a threshold voltage of the first NMOS; and
V3 is also greater than V2 plus Vth2, where Vth2 is a threshold voltage of the second NMOS.

9. The chip as claimed in claim 8, wherein:
V3 is smaller than Vdd1 plus Vth1, and is also smaller than Vdd1 plus Vth2 where Vdd1 is the first voltage source.

10. The chip as claimed in claim 1, wherein:
the drains of the first and second NMOSs are directly coupled to the first voltage source without passing through any transistors.

11. The chip as claimed in claim 10, wherein:
without passing through any transistors, the source of the second NMOS is directly coupled to a low-resistive load driven by the load current.

12. The chip as claimed in claim 1, further comprising:
a current mirror, coupled to a first connection node between the negative input terminal of the operational amplifier and the source of the first NMOS, to determine the first current.

13. The chip as claimed in claim 3, further comprising:
a third NMOS, having a drain coupled to the second connection terminal to provide an additional current path to adjust the load current driving the low-resistive load.
